(19) United States
(12) Patent Application Publication
(10) Pub. No.: US 2017/0031069 A1
(43) Pub. Date: Feb. 2, 2017

(54) Lens Module and method for manufacturing same

(71) Applicant: Jarkko Juha Kristian Viinikanoja, Shenzhen (CN)

(72) Inventor: Jarkko Juha Kristian Viinikanoja, Shenzhen (CN)

(73) Assignee: AAC Technologies Pte. Ltd., Singapore city (SG)

(21) Appl. No.: 15/080,273

(22) Filed: Mar. 24, 2016

(30) Foreign Application Priority Data
Jul. 28, 2015 (CN) 201510451101.5

(51) Int. Cl. G02B 5/20; C03C 17/00; G02B 9/12

(52) U.S. Cl. CPC G02B 5/208; G02B 9/12; C03C 17/00; C03C 2218/15

(57) ABSTRACT

The present disclosure discloses a lens manufacturing method and a lens module equipped with the lenses made by this method. The lens manufacturing method includes following steps: providing a wafer with a first surface and a press mold; pressing the first surface of the wafer onto a shape intended on the press mold for forming a lens array; coating the first surface of the lens array with a light filter film; cutting the wafer into several lenses. The lens disclosed in the present invention can save costs and improve its optical properties.

### FIELD OF THE DISCLOSURE

The present invention relates to a camera lens, and more particularly to a lens module and a manufacturing method to manufacturing the lens module.

### BACKGROUND

In the camera lens module made by existing technology, an infrared filter is installed usually between a lens module and an image sensor to filter infrared light and avoid the influence of infrared light on image. The space of the infrared filter increases the space of the camera lens module, unable to satisfy people's demand for smaller camera module.

For this reason, it is necessary to provide a novel camera lens module to solve problems above.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a flow chart of a method for manufacturing a lens module in accordance with an exemplary embodiment of the present disclosure.

FIG. 2 is an illustration of a lens module manufactured by the method shown in FIG. 1.

### DETAILED DESCRIPTION

The present disclosure will be described in detail below with reference to the attached drawings and an exemplary embodiment thereof.

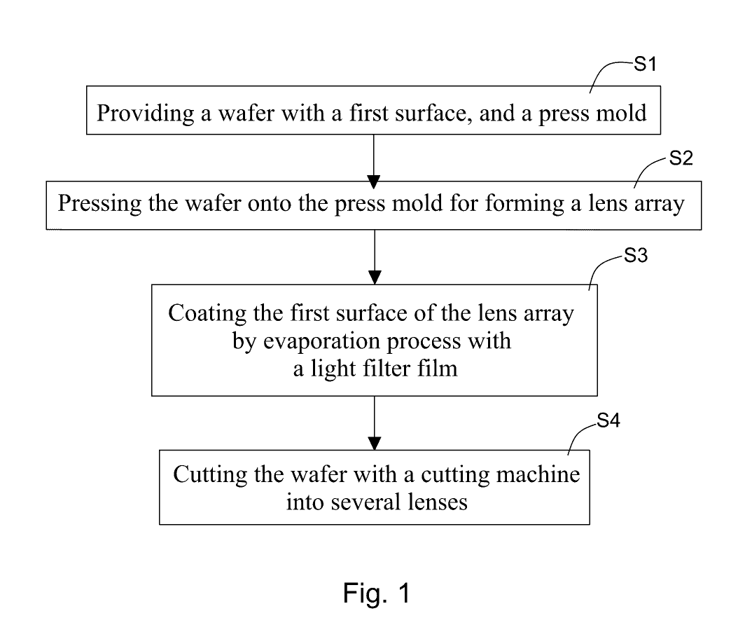

A manufacturing method for manufacturing a lens module, as shown in FIG. 1, includes following steps:

Step S1: Providing a wafer and a press mold. The wafer comprises a first surface and a second surface opposite to the first surface. The wafer can be clamped at the middle of the press mold, so the first surface and the second surface of the wafer can be pressed at same time.

Step S2: Pressing the wafer onto the press mold for forming a lens array. In this embodiment, the first surface of the wafer is pressed on the press mold into a flat surface. The second surface of the wafer is pressed into a concave surface, certainly, also can be pressed also into a convex surface or flat surface.

Step S3: Coating the first surface of the lens array by evaporation process with a light filter film to filter infrared light.

Step S4: Cutting the wafer with a cutting machine into several lenses.

As the light filter film is coated on entire wafer, and then the wafer is cut into individual lenses. This lens manufacturing method is applicable for mass production and can save the cost of production.

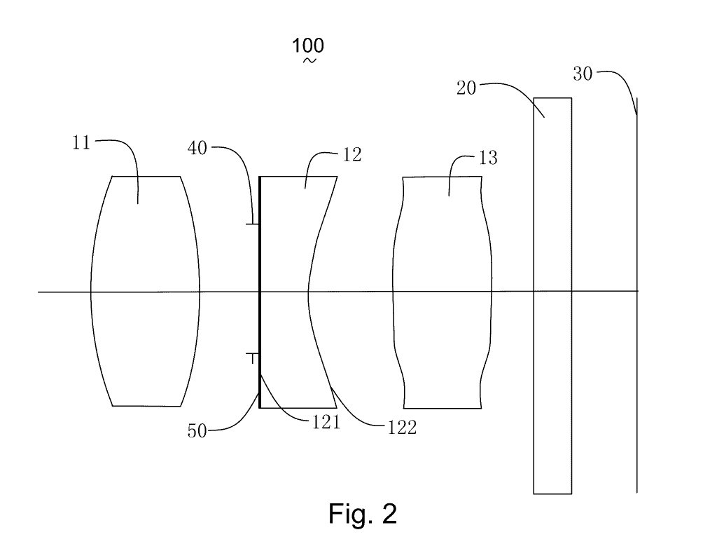

As shown also in FIG. 2, the present disclosure discloses also a camera lens module 100. The camera lens module 100 comprises following parts which are lined up in turn from object side to image side as follows: a first lens 11, a light aperture 40, a second lens 12 and a third lens 13 produced by the lens manufacturing method described above, a glass plate 20 and an image side 30. The image side 30 is provided with an image sensor. In this embodiment, the first lens 11, the second lens 12 and the third lens 13 all have refractive power. In the methods of other embodiment, the camera lens module can comprise also three or more lenses or less than three lenses.

In which, the first surface of the lens is taken as the object side 121 of the second lens 12 and the second surface of the second lens 12 is taken as the image side 122 of the second lens. The light aperture 40 is installed at the object side 121 of the second lens 12. As the second lens is coated with the light filter film, the light source with particular range of near infrared light can pass through the lens module, the influence and interference from other light range are reduced and the image resolution is improved. Total length of the lens module can be reduced effectively while maintaining the features of small camera lens. In addition, as the light filter film 50 and the aperture 40 are installed at the object side 121 of the second lens 12, the camera lens module 100 can be simple and the production cost is reduced. The glass plate may not be coated with the light filter film or the glass plate can be cancelled so as to save the space of the lens module and add more lenses into the lens module, and improve the performance of the lens module thereby.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a lens module, comprising the steps of:
Step S1: Providing a wafer and a pressing mold, the wafer including a first surface;
Step S2: Pressing the first surface of the wafer into a shape intended on the press mold for forming a lens array;
Step S3: Coating the first surface with a light filter film;
Step S4: Cutting the wafer into several lenses.

2. The method for manufacturing a lens module as described in claim 1, wherein the light filter film is used for filtering infrared light.

3. The method for manufacturing a lens module as described in claim 1, wherein the light filter film is coated on the first surface with evaporation process.

4. The method for manufacturing a lens module as described in claim 1, the wafer further comprises a second surface opposite to the first surface, in Step S2, the first surface and the second surface are pressed at the same time into a shape intended on the press mold.

5. The method for manufacturing a lens module as described in claim 1, the first surface of the wafer is pressed into a flat surface on the press mold in step S2.

6. A lens module manufactured by the method as described in claim 1.

7. The lens module as described in claim 6, wherein the lens module comprises, from object side to image side, a first lens, a light aperture, a second lens and a third lens, the first surface of the second lens is taken as the object side of the second lens and the second surface of the second lens is taken as the image side of the second lens.

8. The lens module as described in claim 7, wherein the light aperture is installed at the object side of the second lens.

9. The lens module as described in claim 7, wherein the second lens is made from blue glass.
